(19) United States
(12) Patent Application Publication
(10) Pub. No.: US 2007/0086270 A1
(43) Pub. Date: Apr. 19, 2007

(54) Concrete mixing drum cleanout apparatus and method

(75) Inventors: Thomas J. Harris, Byron, MN (US); Aaron Meyer, Austin, MN (US)

Correspondence Address: NIKOLAI & MERSEREAU, P.A., 900 SECOND AVENUE SOUTH, SUITE 820, MINNEAPOLIS, MN, 55402, US

(73) Assignee: McNeilus Truck and Manufacturing, Inc., Dodge Center, MN (US)

(21) Appl. No.: 11/252,144

(22) Filed: Oct. 17, 2005

(51) Int. Cl. B28C 5/42

(52) U.S. Cl. 366/59; 366/138

(57) ABSTRACT

An integrally mounted apparatus for washing out vehicle-mounted concrete mixing drums is disclosed. The washout apparatus includes an open-ended elongate, relatively rigid shaped hollow guide tube mounted in fixed relation to the support structure support of an inclined mixing drum and extending in fixed relation to the open end of the drum between the fins and charge hopper. A flexible hollow hose is threaded through the guide tube. The hose has a receiving end connected with a source of cleaning fluid under pressure and a discharge end which protrudes from the end of the guide tube as it ends inside the open end of the mixing drum. A forward hose stop is provided for preventing the hose from slipping back down through the guide tube and a rear hose stop is provided for limiting the travel of the discharge end of the hose outward from the end of the guide tube.

### BACKGROUND OF THE INVENTION

I. Field of the Invention

The present invention relates generally to systems for washing out concrete mixing drums to remove residual concrete products from such drums and, more particularly, to an integral washout system including a guide device mounted in fixed relation to such a drum that is particularly suited to vehicle-mounted mixing drums including non-metallic drums.

II. Related Art

Transit concrete mixing trucks, sometimes referred to as ready-mix trucks, have long been in use. They are equipped with a large chassis-mounted rotatable mixing drum for mixing and dispensing a quantity of concrete. The drums typically are mounted on an incline and have an opening in the upper end for receiving ingredients to be mixed and discharging mixed (charging) concrete products. Loading is accomplished through a charge hopper which extends a distance into the opening of the drum. The charge hopper may be designed to pivot and swing clear of the opening during the discharging operation. The drum is further provided with internal helical flights or fins extending around its internal surface which acts to mix the concrete when the drum is caused to rotate in one direction and cause the concrete to be discharged out of the opening when the rotation of the drum is reversed. The upper portion of the drum includes a ring and roller system for drum support and rotation that is carried by a heavy pedestal support assembly. After mixing and discharge, such concrete mixing drums retain an amount of residual concrete on the mixing fins and inner drum surface which needs to be periodically washed out to prevent it from curing and hardening inside the drum. Therefore it has become part of the operating routine to wash the interior of the drum one or more times per day. It has further become a common practice to use external manually operated devices to accomplish the washout task. Manual cleaning has typically involved a worker entering the drum with a water hose and hand tools to clean the drum.

Independent external probe and nozzle devices have also been proposed such as that shown in U.S. Pat. Nos. 6,418,948 and 6,640,817 to Harmon. A further truck-mounted system for washing a charge hopper and discharge chute with provision for containing and filtering rinse water is shown in U.S. Pat. Nos. 6,155,277 and 6,866,047 to Barry or Marvin. Those systems rely on manual manipulation of flexible conduits for both washing and collection.

While some of these devices have met with a degree of success, there remains a need for a washout system that is permanently mounted with respect to the drum as a part of a mixer system. That would further reduce the need for manual interaction and the risk of equipment damage by ensuring that the washout hose remains clear of both mixing fin and charge hopper when the mixer is operated during cleanout.

### SUMMARY OF THE INVENTION

By means of the present invention, there is provided an integrally mounted apparatus particularly suitable for washing out vehicle-mounted concrete mixing drums. The washout apparatus includes an open-ended elongate, relatively rigid shaped hollow guide tube mounted in fixed relation to the support structure support for a mixing drum and extending to a point within and in fixed relation to the opening in the upper end of the drum between the fins and charge hopper. A flexible hollow hose is threaded through the guide tube. The hose has a receiving end connected with a source of cleaning fluid under pressure and a discharge end which protrudes from the end of the guide tube as it ends inside the open end of the mixing drum. A forward hose stop in the form of a clamp-on device of a larger diameter than the guide tube is provided for preventing the hose from slipping back down through the guide tube and a similar rear hose stop is provided for limiting the travel of the discharge end of the hose outward from the end of the guide tube.

The source of cleaning fluid under pressure, is normally a water supply tank carried on the transit mixer truck which is provided with an associated pump outlet manifold and valving system to supply fluid under pressure through a manually operated valve to the connected flexible hose.

The guide tube and hose are preferably of non-metallic material, the guide tube being preferably PVC tubing and the hose can be of garden hose material.

### BRIEF DESCRIPTION OF THE DRAWINGS

In the drawings wherein like numerals depict like parts throughout the same:

FIG. 1 is a schematic representation of a mixer drum washout system in accordance with the invention with parts broken away for convenience;

FIG. 2 is a partial perspective view of the rear portion of a mixer vehicle showing a washout guide tube in accordance with the invention;

FIG. 3 is a partial rear view of a mixer vehicle depicting the washout guide tube of FIG. 2;

FIG. 4 is an enlarged fragmentary view showing the positioning of the end of the guide tube of the invention in the drum opening; and

FIG. 5 is a schematic drawing of a drum showing the interior mixing fin flights in a possible cleanout posture.

### DETAILED DESCRIPTION

The detailed description portrays an example of the washout system of the invention that is meant to illustrate the inventive concepts but is not intended to limit the scope of the invention. With this in mind, the details will now be described

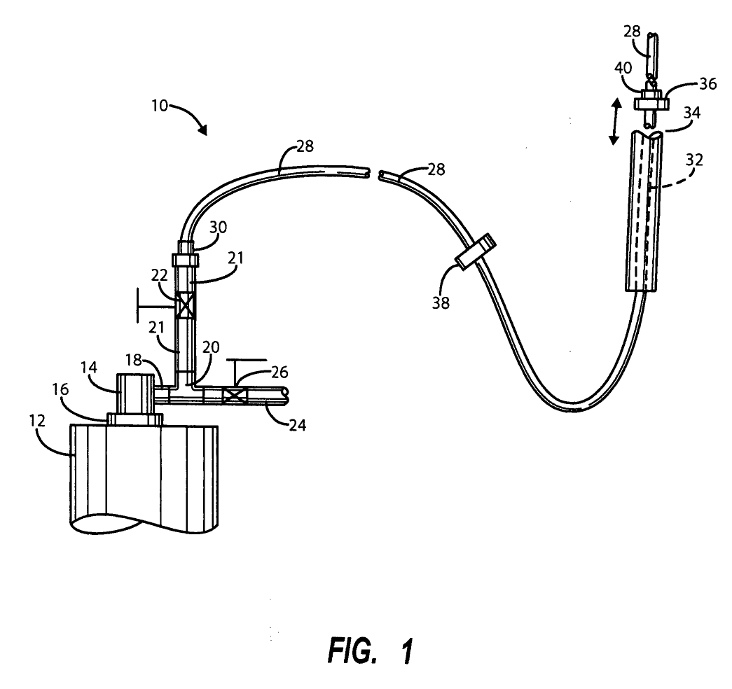

FIG. 1 is a schematic representation with parts broken away of a washout system that incorporates the present invention. The washout system, shown generally at 10, includes a water tank reservoir 12 and associated pump 14 which may be an electric diaphragm pump or other suitable such device mounted on a platform 16 situated atop the tank or reservoir 12. Such pump and tank arrangements are known. The pump discharge outlet or high pressure line 18 includes a female T-fitting 20 which splits the outlet into two lines including the washout line 21 suitably valved at 22 and a second line 24 with a valve 26. The line 21 is suitably connected to a washout hose 28 at 30. The hose 28 is further threaded through guide tube 32 shown broken at 34 and is provided with forward and rear hose stops 36 and 38, respectively. An end cap may be provided at 40 when the system is not in use.

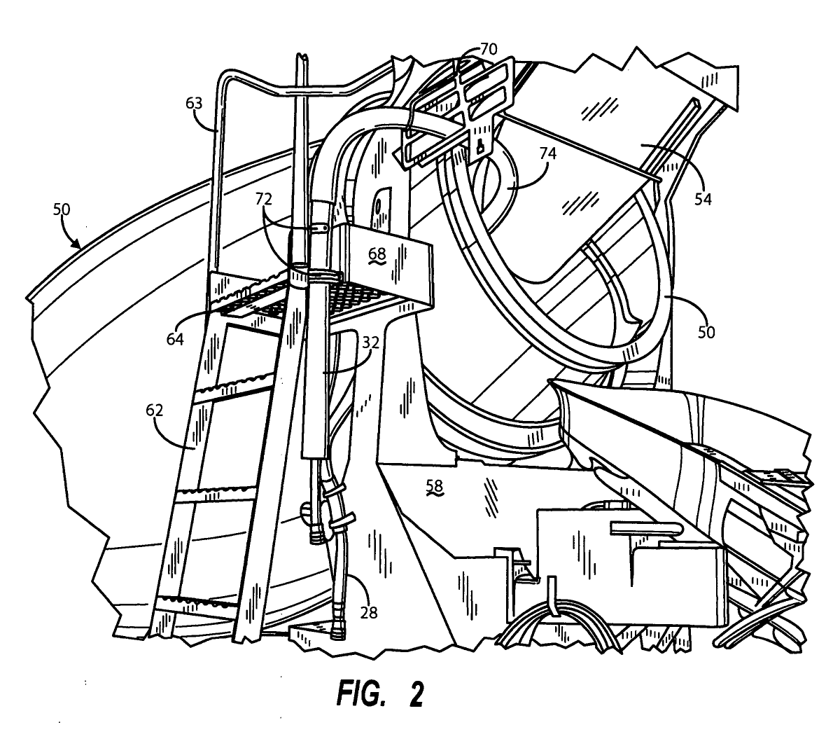

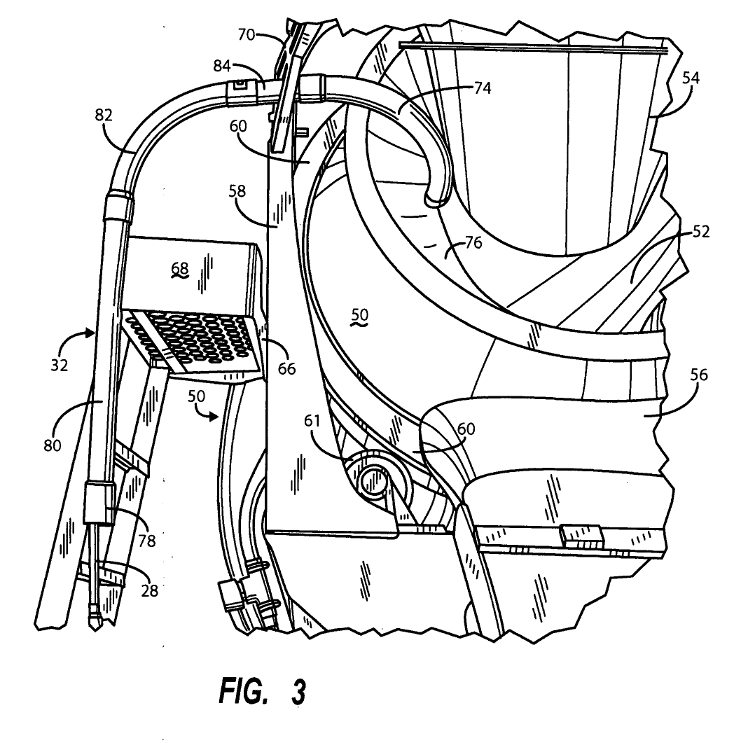

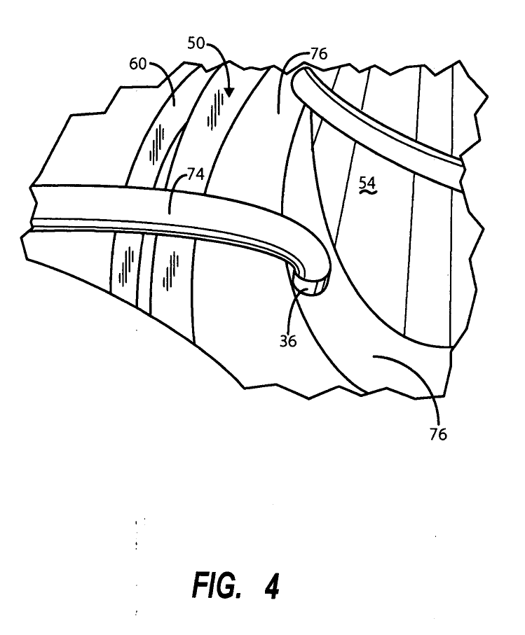

FIGS. 2-4 show the guide tube mounting in relation to the charge/discharge section of a vehicle-mounted concrete mixing drum at 50 with the charge/discharge opening at 52 including a charge hopper 54 and a discharge chute 56. A rear support structure is shown in part at 58 and a support ring is shown at 60 which rides on suitable support rollers as at 61 (FIG. 3). The upper section of an access ladder is shown at 62 with railing 63 and associated top access platform 64 which is fixed to the support structure 58 at 66 and includes a heavy gauge sidewall 68. The drum support structure also carries a mixer guard grid arrangement shown in part at 70.

The guard tube 32 is fixed to the sidewall 68 of the access platform 64 as by EMT clips 72 and is thought to extend through the mixer guard grid arrangement to be positioned so that the end of the curved section 74 of the guide tube 32, which may be a street elbow, is located between the helical mixing fins shown at 76 and the charge hopper 54. Clearance must be maintained between the washout system and the charge hopper during charge hopper movement particularly when it is in the lowered or charge position as shown in the figures and also in the discharge (pivoted away) position. The guide tube of the system must also clear the mixing fins and clear concrete being discharged from the opening. The forward hose stop 36 is positioned near the discharge end of the hose and prevents the washout hose 28 from slipping back through the guide tube 30. The washout hose 28 can be extended to protrude a distance into the mixing drum until the rear hose stop 38 engages the lower end 78 of the guide tube 32.

Guide tube 32 may consist of a straight section 80 connected to a second street elbow 82 and a short nipple 84 connected to street elbow 74. The guide tube is preferably a non-metallic rigid material such as PVC tubing and is typically about 2″ (5.08 cm) in diameter.

An important aspect of the washout system of the present invention involves the use a permanently mounted guide tube associated with the washout operation. This eliminates the need for a separate auxiliary device which is used to access the charge/discharge opening of the mixer. It also eliminates the need for an operator to carefully steer a cleanout device between the charge hopper and mixing fins each time washout is required.

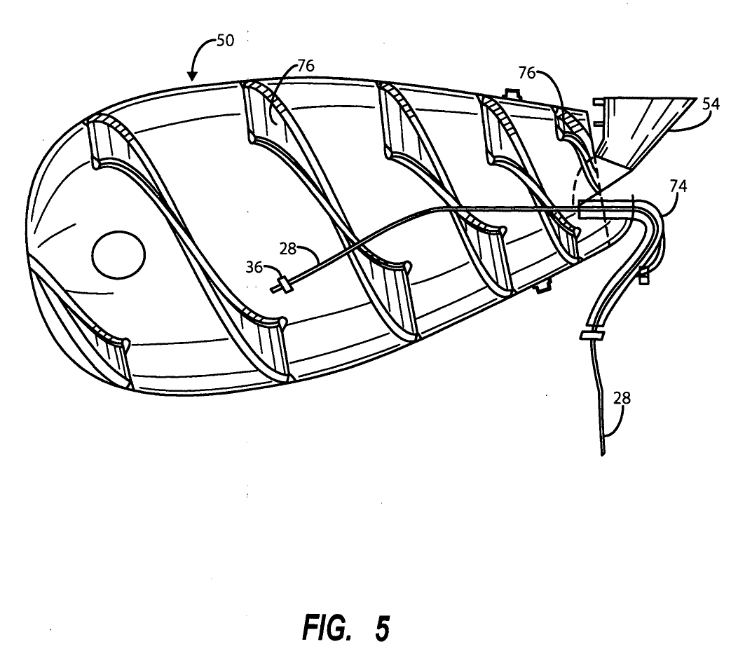

It should be noted that as shown in FIG. 5, the hose 28 can be extended well into the mixer drum and tools can be used on conjunction with the hose. The system of the present invention is particularly well-suited for use with drums and fins which are of a non-metallic material such as fiberglass and urethanes.

To operate the cleanout system, the pump 14 is activated prior to cleanout and the valve 22 opened after removal of cap 40 so that cleanout fluid under high pressure can be blasted into the drum with the operator extending the base 28 into the drum and/or adding tools to the discharge end of base 28 as desired. The hose is withdrawn and the drum operated to rotate in the mixing direction to clean residual material from the internal surface. The rotation of the drum is then reversed and the cleanout fluid (normally water) is discharged with the residual material as slurry.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. An apparatus for washing out a concrete mixing drum having an upper end with an opening therein for charging concrete ingredient materials and discharging mixed concrete said opening being accessed by a fresto-conical charging hopper comprising:
(a) a concrete mixing drum support structure for supporting a concrete mixing drum of an incline toward the upper end thereof;
(b) an elongate, relatively rigid shaped hollow guide tube mounted in fixed relation to the concrete mixing drum support structure and having a first open end disposed in fixed relation to an opening in a concrete mixing drum and a second open end;
(c) a flexible hollow hose conduit threaded through said guide tube having a receiving end connected with a source of cleaning fluid under pressure and a discharge end protruding from said first end of said guide tube.

2. An apparatus as in claim 1 further comprising a forward hose stop for retaining said hose in said guide tube and a rear hose stop for limiting the travel of said discharge end of said hose outward from said first end of said guide tube.

3. An apparatus as in claim 1 further comprising a concrete mixing drum equipped with a tiltable charge hopper and helical mixing fin mounted on said support structure, said guide tube being mounted so that the first end thereof is located in the opening in the drum between said charge hopper and said mixing fin such that said hose will discharge fluid therebetween.

4. An apparatus as in claim 1 further comprising a valve connected between said source of fluid under pressure and said hose.

5. An apparatus as in claim 3 wherein said mixing drum is of non-metallic construction.

6. An apparatus as in claim 1 wherein said guide tube is non-metallic.

7. An apparatus as in claim 1 wherein said source of fluid under pressure includes a fluid pump and reservoir.

8. An integral apparatus for washing out a vehicle-mounted concrete mixing drum comprising:
(a) a vehicle-mounted concrete mixing drum having an inclined posture with an upper end and an opening in the upper end for receiving charges of ingredient materials to be mixed and for discharging mixed concrete;
(b) a drum support structure for supporting the mixing drum toward the upper end thereof;
(c) an open-ended elongate, relatively rigid shaped hollow guide tube mounted in fixed relation to said drum support structure and said opening of said mixing drum and having an open upper end and an aspect extending into said opening in said drum; and
(d) a flexible hose threaded through said guide tube having a receiving end connected to a source of fluid under pressure and a discharge end protruding from said open upper end of said guide tube so as to selectively direct cleaning fluid into said drum.

9. An apparatus as in claim 8 wherein said mixing drum is of non-metallic construction.

10. An apparatus as in claim 8 wherein said source of fluid under pressure includes a fluid pump and reservoir and said system further comprises a valve connected between said source of fluid under pressure and said hose.

11. An apparatus as claim 8 further comprising a forward hose stop for retaining said hose in said guide tube, and a rear hose stop for limiting the travel of said discharge end of said hose outward from the said first end of said guide tube.

12. A method of washing out a concrete mixing drum comprising steps of:
(a) providing a fixed end of a washout apparatus as in claim 1;
(b) selectively administering fluid under pressure into the open end of said drum while rotating said drum in the first direction; and
(c) reversing the rotation of said drum to remove residual concrete as slurry.
